(19) United States
(12) Patent Application Publication
(10) Pub. No.: US 2019/0372809 A1
(43) Pub. Date: Dec. 5, 2019

(54) WIRELESS RECEIVER

(71) Applicant: Korea Advanced Institute of Science and Technology, Daejeon (KR)

(72) Inventors: Sang Gug LEE, Daejeon (KR); Hyun Gi SEOK, Daejeon (KR); Oh Yong JUNG, Daejeon (KR); Keun Mok KIM, Daejeon (KR); Kyung Sik CHOI, Daejeon (KR); Seok Kyun HAN, Daejeon (KR)

(21) Appl. No.: 16/125,439

(22) Filed: Sep. 7, 2018

(30) Foreign Application Priority Data
Jun. 1, 2018 (KR) 10-2018-0063689

(51) Int. Cl. H04L 27/14; H04B 1/26

(52) U.S. Cl. CPC H04L 27/14; H04B 1/26

(57) ABSTRACT

There is provided a wireless receiver. The wireless receiver includes an IQ modulator configured to generate an in-phase signal and a quadrature-phase signal from input signals modulated by a frequency modulation scheme and a modulation scheme converter configured to convert a modulation scheme of the in-phase signal and the quadrature-phase signal outputted from the IQ modulator into an amplitude modulation scheme. Further, the wireless receiver includes a bandpass filter configured to pass bandpass signals in which the modulation scheme is converted into the amplitude modulation scheme by the modulation scheme converter.

### CROSS-REFERENCE TO RELATED APPLICATIONS

This application is based on and claims priority to Korean Patent Application No. 10-2018-0063689, filed on Jun. 1, 2018, the disclosure of which is incorporated herein in its entirety by reference.

### TECHNICAL FIELD

The present disclosure relates to a wireless receiver.

### BACKGROUND

The Internet of Things (IoT) has been widely applied to various fields such as healthcare, home automation and autonomous navigation, and is implemented through monitoring and sensing information in the applications of such fields. Human lives are becoming more convenient through IoT.

Wireless receivers can be used for IoT networks to monitor and sense information between various applications. Such wireless receivers should be able to receive or recognize a variety of events or information with high sensitivity even in cases where limited power is supplied from a power source, e.g., a battery having limited capacity. Otherwise, the complexity of the entire network may increase, thereby degrading the performance and increasing the power consumption of the network.

Meanwhile, a signal received and processed by a wireless receiver may be modulated by one of various modulation schemes. For example, the signal may be a signal (hereinafter, referred to as ‘an FSK modulation signal’) modulated through frequency shift keying (FSK) or may be a signal (hereinafter, referred to as ‘an OOK modulation signal’) modulated through on-off keying (OOK), which is a type of amplitude shift keying (ASK) schemes. Besides, the signal may be a signal modulated by another modulation scheme that is not mentioned above.

Depending on the modulation scheme applied to the signal, each signal has different characteristics. By way of example, the characteristics of the FSK modulation signal and the OOK modulation signal will be described and compared. The FSK modulation signal is relatively robust to noise and interference signals, but may have relatively high power consumption during demodulation as compared with the OOK modulation signal. On the other hand, the OOK modulation signal may have relatively low power consumption during demodulation, but is relatively weak to noise and interference signals as compared with the FSK modulation signal.

As such, the signal has different characteristics depending on the modulation scheme applied thereto, which may affect the performance of wireless receivers. For example, the power consumption and the reception sensitivity in the wireless receiver may vary depending on the modulation scheme applied to the signal. Accordingly, various studies are being conducted to improve the performance of wireless receivers while considering the modulation scheme applied to the signal (see, e.g., Korean Patent Application Publication No. 10-2016-0109931).

### SUMMARY

In view of the above, aspects of the present disclosure provide a wireless receiver designed in consideration of a modulation scheme of a signal to have low power consumption and characteristics robust to interference signals.

However, aspects of the present disclosure are not restricted to those set forth herein. The above and other aspects of the present disclosure will become more apparent to those skilled in the art to which the present disclosure pertains by referencing the detailed description of the present disclosure given below.

In accordance with an embodiment of the present disclosure, there is provided a wireless receiver including: an IQ modulator configured to generate an in-phase signal and a quadrature-phase signal from input signals modulated by a frequency modulation scheme, a modulation scheme converter configured to convert a modulation scheme of the in-phase signal and the quadrature-phase signal outputted from the IQ modulator into an amplitude modulation scheme, and a bandpass filter configured to pass bandpass signals in which the modulation scheme has been converted into the amplitude modulation scheme by the modulation scheme converter.

Further, the input signals modulated by the frequency modulation scheme may be signals modulated by frequency shift keying.

Further, the amplitude modulation scheme may be on-off keying.

Further, the modulation scheme converter may include a poly-phase filter.

Further, the bandpass filter may include an N-path filter.

Further, the modulation scheme converter may include a poly-phase filter that is configured to suppress an aliasing effect caused by the N-path filter.

In accordance with the embodiment of the present disclosure, it is possible to provide a wireless receiver t is robust to noise and interference signals and reduces power consumption.

Further, it is possible to remove or prevent the aliasing effect that may occur in a part of the configurations included in the wireless receiver without any additional circuits serving as the anti-aliasing filter.

Further, it is possible to supply a noise-free switching signal generated in the wireless receiver to the bandpass filter unit included in the wireless receiver.

### BRIEF DESCRIPTION OF THE DRAWINGS

The objects and features of the disclosure will become apparent from the following description of embodiments, given in conjunction with the accompanying drawings, in which:

FIG. 1 is a circuit diagram showing a configuration of a wireless receiver according to a first embodiment.

FIG. 2 is a circuit diagram showing a configuration of a wireless receiver 1000′ according to a second embodiment.

FIG. 3 is a circuit diagram showing a configuration of a wireless receiver 1000″ according to a third embodiment.

### DETAILED DESCRIPTION

The advantages and features of the present disclosure and the methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

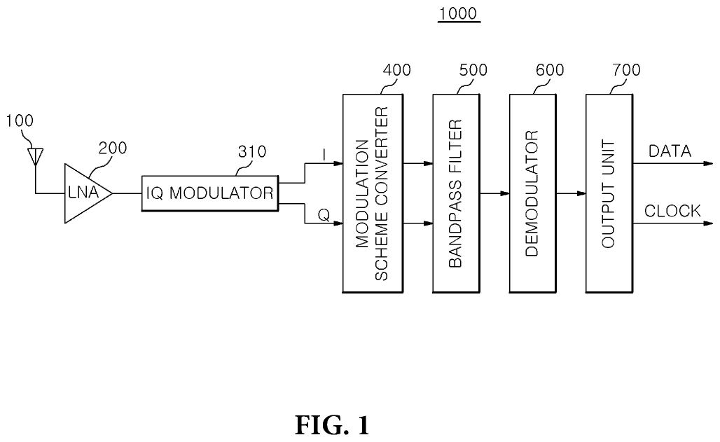

FIG. 1 is a circuit diagram showing a configuration of a wireless receiver 1000 according to a first embodiment of the present disclosure.

Referring to FIG. 1, the wireless receiver 1000 may include an antenna 100, a low-noise amplifier 200, an IQ modulator 310, a modulation scheme converter 400, a bandpass filter 500, a demodulator 600, and an output unit 700. However, depending on an embodiment, the wireless receiver 1000 may not include at least one of the configurations described above or may further include another configuration that is not described above.

The antenna 100 is configured to receive an external signal (RF input signal). The signal received through the antenna 100 may be modulated by one of various modulation schemes. For example, the signal received through the antenna 100 may be modulated in frequency shift keying (FSK) and referred to as an FSK modulation signal. In the present embodiment, further description will be based on the assumption that the signal received through the antenna 100 is the FSK modulation signal.

The low-noise amplifier (LNA) 200 is configured to amplify a signal. The low-noise amplifier 200 may include, e.g., a transistor, a resonant circuit or the like.

Hereinafter, descriptions will be given to explain the operations of the IQ modulator 310, the modulation scheme converter 400, and the bandpass filter 500 shown in FIG. 1.

The IQ modulator 310 is configured to generate and output an in-phase signal and a quadrature-phase signal from the input signal. The in-phase signal and the quadrature-phase signal may have a predetermined phase difference. For example, the phase difference between the in-phase signal and the quadrature-phase signal may be 90°, but the present embodiment is not limited thereto.

The modulation scheme converter 400 is configured to convert the modulation scheme of the input signal from one to another and output the converted modulation scheme. The modulation scheme converter 400 may be, e.g., a poly-phase filter (PPF). Here, it is a known method of converting the modulation scheme of the input signal from one to another in case where the modulation scheme converter 400 is the poly-phase filter, and thus a description thereof will be omitted. Meanwhile, when the modulation scheme converter 400 is the poly-phase filter, the modulation scheme converter 400 may serve as an anti-aliasing filter.

When the input signal is an FSK modulation signal that is modulated in FSK, the modulation scheme converter 400 may convert the modulation scheme of the input signal into on-off keying (OOK), which is a type of amplitude shift keying (ASK) schemes, thereby outputting an OOK modulation signal.

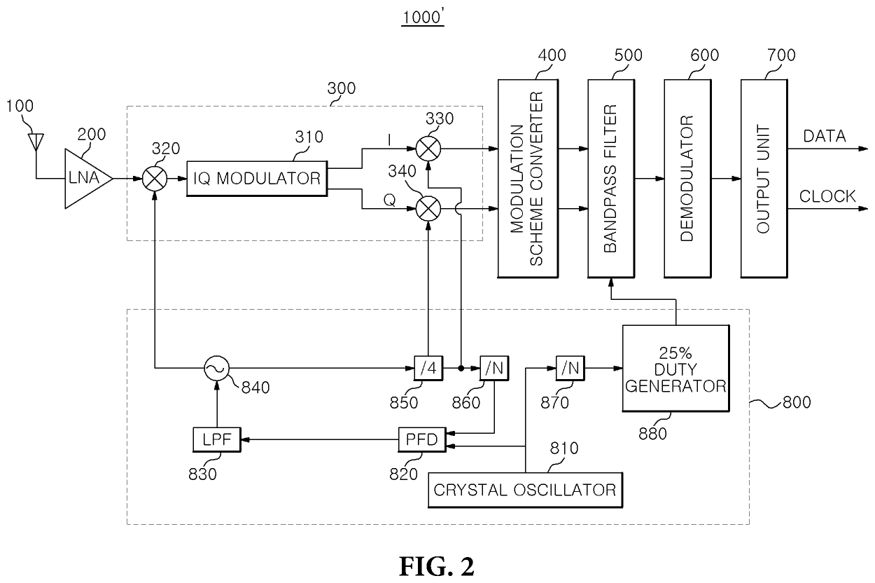

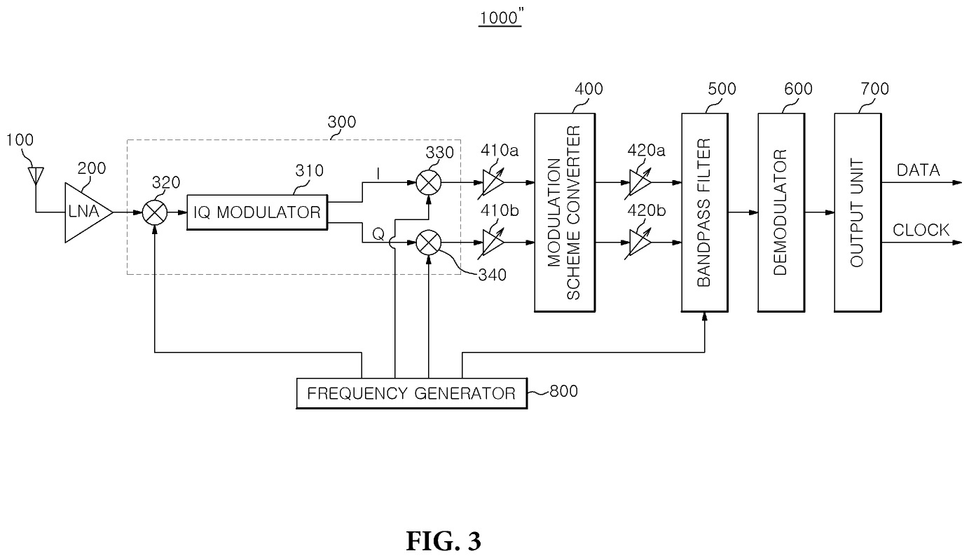

The bandpass filter 500 is configured to, from the input signal, pass frequencies within a predetermined frequency band and attenuate frequencies outside the predetermined frequency band so as to provide a filtered output signal. Although it is not shown in FIG. 1, the bandpass filter 500 receives a signal having a predetermined frequency, which will be described in more detail with reference to FIGS. 2 and 3.

Further, the bandpass filter 500 may be, e.g., an N-path filter. In the filtering process performed by using the N-path filter as the band-pass filter 500, a certain frequency noise is folded into a frequency band of the input signal due to an aliasing effect.

Hereinafter, descriptions will be given to explain a signal flow and a signal processing operation in the IQ modulator 310, the modulation scheme converter 400, and the bandpass filter 500.

When a signal amplified by the low-noise amplifier 200 is inputted to the IQ modulator 310, the IQ modulator 310 generates and outputs an in-phase signal and a quadrature-phase signal from the received signal. The in-phase signal and the quadrature-phase signal may have a predetermined phase difference of, e.g., 90°.

The modulation scheme converter 400 receives the in-phase signal and the quadrature-phase signal from the IQ modulator 310. As described above, the signal received through the antenna 100 is the FSK modulation signal that is modulated in FSK. Therefore, the modulation scheme for the in-phase signal and the quadrature-phase signal received from the IQ modulator 310 to the modulation scheme converter 400 is also frequency shift keying (FSK).

The modulation scheme converter 400 converts the modulation scheme for the in-phase signal and the quadrature-phase signal into on-off keying (OOK), which is a type of amplitude shift keying (ASK) schemes, thereby outputting the OOK modulation signal.

The bandpass filter 500 receives the OOK modulation signal from the modulation scheme converter 400 to perform bandpass filtering.

Here, when the poly-phase filter is used as the modulation scheme converter 400, the modulation scheme converter 400 is required to receive the in-phase signal and the quadrature-phase signal in order to perform the FSK-to-OOL modulation conversion described above. Therefore, in the wireless receiver 1000 according to the first embodiment, the IQ modulator 310 provides the in-phase signal and the quadrature-phase signal to the modulation scheme converter 400.

Further, when the N-path filter is used as the bandpass filter 500, the aliasing effect may occur during the filtering process. This aliasing effect degrades the signal-to-noise ratio (SNR) of the signal, which leads to low sensitivity in the wireless receiver 1000. Therefore, in the wireless receiver 1000 according to the first embodiment, the modulation scheme converter 400, which is the poly-phase filter, may serve as an anti-aliasing filter that prevents or removes the aliasing effect. In other words, the anti-aliasing effect can be achieved without an additional anti-aliasing filter since the modulation scheme converter 400, which is a poly-phase filter, acts as the anti-aliasing filter.

Next, the demodulator 600 is configured to receive and demodulate the filtered signal from the bandpass filter 500. Here, the filtered signal outputted from the bandpass filter 500 is the OOK modulation signal modulated in OOK. The OOK modulation signal is advantageous in that relatively low power consumption can be achieved during demodulation as compared to the FSK modulation signal.

The output unit 700 is configured to output the demodulated signal from the demodulator 600. The output signal includes data corresponding to the signal transmitted from the antenna 100 to the low-noise amplifier 200 and a clock having a predetermined frequency.

As described above, the wireless receiver 1000 according to the first embodiment receives the FSK modulation signal, which is relatively robust to noise and interference signals compared with the OOK modulation signal, as the input signal. Meanwhile, in the internal signal process of the wireless receiver 1000, the FSK modulation signal inputted thereto is converted into the OOK modulation signal, and the demodulation is carried out by employing a method suitable for the relatively low power consumption of the OOK modulation signal during demodulation when compared with the FSK modulation signal.

Therefore, the wireless receiver 1000 of the first embodiment not only has characteristics strong to noise and interference (which is an advantage of using the FSK modulation signal) but also has characteristics of low power consumption (which is an advantage of using the OOK modulation signal).

Further, according to the wireless receiver 1000 of the first embodiment, the poly-phase filter is used for the modulation scheme converter 400 so that the aliasing effect, which may occur when the N-path filter is used for the bandpass filter 500 can be removed or prevented without any additional filter circuit.

FIG. 2 is a circuit diagram showing a configuration of a wireless receiver 1000′ according to a second embodiment.

Referring to FIG. 2, the wireless receiver 1000′ according to the second embodiment includes the antenna 100, the low-noise amplifier 200, a sliding-IF (intermediate frequency) structure unit 300, the modulation scheme converter 400, the bandpass filter 500, the demodulator 600, the output unit 700, and a frequency generator 800. However, depending on the embodiment, the wireless receiver 1000′ may not include at least one of the configurations described above or may further include another configuration that is not described above.

Further, the wireless receiver 1000′ shown in FIG. 2 also includes the following configurations as compared to the wireless receiver 1000 according to the first embodiment shown in FIG. 1:

(1) a first mixer 320 that is connected between an input terminal of the IQ modulator 310 and an output terminal of the low-noise amplifier 200;

(2) a second mixer 330 that is connected between an output terminal of the IQ modulator 310 for outputting the in-phase signal and an input terminal of the modulation scheme converter 400;

(3) a third mixer 340 that is connected between an output terminal of the IQ modulator 310 for outputting the quadrature-phase signal and the input terminal of the modulation scheme converter 400;

(4) the frequency generator 800 that is connected to the first mixer 320, the second mixer 330, the third mixer 340 and the bandpass filter 500.

Further, the antenna 100, the low-noise amplifier 200, the modulation scheme converter 400, the bandpass filter 500, the demodulator 600, and the output unit 700 shown in FIG. 2 have the same configurations as those in the wireless receiver 1000 according to the first embodiment shown in FIG. 1. Therefore, redundant descriptions thereof will be omitted, and the following description will focus on the configurations different from FIG. 1.

The frequency generator 800 will first be described. The frequency generator 800 includes a crystal oscillator 810 that outputs a signal having a predetermined frequency.

The signal outputted from the crystal oscillator 810 is inputted to a signal distributor 840 through a phase-frequency detector (PFD) 820 and a low-pass filter (LPF) 830.

Further, the signal outputted from the crystal oscillator 810 is inputted to a 25% duty cycle generator 880 through a frequency divider 870 and is outputted to the bandpass filter 500 through the 25% duty cycle generator 880. Therefore, when the N-path filter is used for the bandpass filter 500, a noise-free switching signal generated in the wireless receiver 1000′ may be inputted to the N-path filter.

The signal inputted to the signal distributor 840 is outputted to the first mixer 320. The first mixer 320 down-converts the signal received from the low-noise amplifier 220 based on the signal received from the signal distributor 840 and, then, the down-converted signal is outputted to the IQ modulator 310.

Further, the signal inputted to the signal distributor 840 is also outputted to the second mixer 330 and the third mixer 340 through a frequency divider 850 and is further outputted to the phase-frequency detector 820 through another frequency divider 860.

Here, the second mixer 330 down-converts an in-phase signal received from the IQ modulator 310 based on the signal received from the frequency divider 850 and, then, the down-converted in-phase signal is outputted to the modulation scheme converter 400.

Further, the third mixer 340 down-converts a quadrature-phase signal received from the IQ modulator 310 based on the signal received from the frequency divider 850 and, then, the down-converted quadrature-phase signal is outputted to the modulation scheme converter 400.

Here, for the signal inputted to the signal distributor 840 from the crystal oscillator 810 through the PFD 820 and the LPF 830, the signal inputted to the first mixer 320 from the signal distributor 840 may have ⅘ radio frequency of the signal inputted to the signal distributor 840 and the signal inputted to the second mixer 330 and the third mixer 340 may have ⅕ radio frequency of the signal inputted to the signal distributor 840.

As described above, according to the second embodiment, the signal can be down-converted during the process of transmitting the signal from the low-noise amplifier 200 to the modulation scheme converter 400, which is called a sliding-IF (intermediate frequency) structure. Thus, in FIG. 2, a component denoted by reference numeral “300” is referred to as the sliding-IF structure unit 300. With this sliding-IF structure that allows the signal to be down-converted, the power consumption when generating the in-phase signal and the quadrature-phase signal in the IQ modulator 310 can be effectively reduced as compared to the case without the sliding-IF structure.

Further, the RF input signals are down-converted twice in FIG. 2, but the present disclosure is not limited thereto. For example, the RF signals may be down-converted only once depending on the embodiment. To this end, the wireless receiver 1000′ may include only the second and third mixers 330 and 340 without the first mixer 320, or may include only the first mixer 320 without the second and third mixers 330 and 340.

FIG. 3 is a circuit diagram showing a configuration of a wireless receiver 1000″ according to a third embodiment.

Referring to FIG. 3, the wireless receiver 1000″ according to the third embodiment includes the antenna 100, the low-noise amplifier 200, the sliding-IF (intermediate frequency) structure unit 300, the modulation scheme converter 400, the bandpass filter 500, the demodulator 600, the output unit 700, the frequency generator 800, first amplifiers 410a and 410b, and second amplifiers 420a and 420b. However, depending on the embodiment, the wireless receiver 1000″ may not include at least one of the configurations described above or may further include other configurations not described above. Further, the frequency generator 800 may have the same configuration and functions as those of the frequency generator 800 shown in FIG. 2.

Further, the wireless receiver 1000″ shown in FIG. 3 also includes the following configurations as compared to the wireless receiver 1000′ according to the second embodiment shown in FIG. 2:

(1) a first amplifier 410a that is connected between an output terminal of the second mixer 330 and an input terminal of the modulation scheme converter 400;

(2) a first amplifier 410b that is connected between an output terminal of the third mixer 340 and the input terminal of the modulation scheme converter 400;

(3) second amplifiers 420a and 420b that are connected between output terminals of the modulation scheme converter 400 and input terminals of the bandpass filter 500;

Further, the antenna 100, the low-noise amplifier 200, the sliding-IF (intermediate frequency) structure unit 300, the modulation scheme converter 400, the bandpass filter 500, the demodulator 600, the output unit 700 and the frequency generator 800 shown in FIG. 3 have the same configurations as those in the wireless receiver 1000 according to the first embodiment shown in FIG. 1 or the wireless receiver 1000′ according to the second embodiment shown in FIG. 2. Therefore, redundant descriptions thereof will be omitted, and the following description will focus on the configurations different from FIGS. 1 and 2.

The first amplifier 410a is configured to amplify the down-converted in-phase signal from the second mixer 330 and output the amplified in-phase signal to the modulation scheme converter 400. The first amplifier 410b is configured to amplify the down-converted quadrature-phase signal from the third mixer 340 and output the amplified quadrature-phase signal to the modulation scheme converter 400. With the amplifications performed by the first amplifiers 410a and 410b, it is possible to reduce or eliminate the noise figure (NF) of the signal.

The second amplifiers 420a and 420b are configured to amplify the signals outputted from the modulation scheme converter 400 and output the amplified signals to the bandpass filter 500.

In accordance with the embodiments of the present disclosure described above, the wireless receiver provides the FSK-to-OOK modulation conversion, where the RF input signals are modulated in FSK so as to be robust to noise and interference, while the down-converted signals are modulated in OOK so as to reduce total power consumption. Therefore, the wireless receiver according to the embodiments of the present disclosure can take advantage of both FSK (noise/interference robustness) and OOK (low power consumption) at the same time.

In addition, since the poly-phase filter acts as the anti-aliasing filter, the aliasing effect that may occur in certain configurations included in the wireless receiver can be eliminated or suppressed without any additional circuit serving as the anti-aliasing filter.

Further, the noise-free switching signal generated in the wireless receiver can be supplied to the bandpass filter unit included in the wireless receiver.

As described above, those skilled in the art will understand that the present disclosure can be implemented in other forms without changing the technical idea or essential features thereof. Therefore, it should be understood that the above-described embodiments are merely examples, and are not intended to limit the present disclosure. The scope of the present disclosure is defined by the accompanying claims rather than the detailed description, and the meaning and scope of the claims and all changes and modifications derived from the equivalents thereof should be interpreted as being included in the scope of the present disclosure.

What is claimed is:

1. A wireless receiver comprising:
an IQ modulator configured to generate an in-phase signal and a quadrature-phase signal from input signals modulated by a frequency modulation scheme;
a modulation scheme converter configured to convert a modulation scheme of the in-phase signal and the quadrature-phase signal outputted from the IQ modulator into an amplitude modulation scheme; and
a bandpass filter configured to pass bandpass signals in which the modulation scheme is converted into the amplitude modulation scheme by the modulation scheme converter.

2. The wireless receiver of claim 1, wherein the input signals modulated by the frequency modulation scheme are signals modulated by frequency shift keying.

3. The wireless receiver of claim 1, wherein the amplitude modulation scheme is on-off keying.

4. The wireless receiver of claim 1, wherein the modulation scheme converter includes a poly-phase filter.

5. The wireless receiver of claim 1, wherein the bandpass filter includes an N-path filter.

6. The wireless receiver of claim 5, wherein the modulation scheme converter includes a poly-phase filter that is configured to suppress an aliasing effect caused by the N-path filter.
